(19) United States
(12) Patent Application Publication
(10) Pub. No.: US 2014/0104388 A1
(43) Pub. Date: Apr. 17, 2014

(54) Optical Lens Module Assembly With Auto Focus and 3-D Imaging Function

(71) Applicant: Medha Dharmatilleke, Mason, OH (US)

(72) Inventor: Medha Dharmatilleke, Mason, OH (US)

(21) Appl. No.: 13/865,283

(22) Filed: Apr. 18, 2013

Related U.S. Application Data
(63) Continuation of application No. PCT/SG2011/000315, filed on Sep. 15, 2011.
Application No. PCT/SG2011/000315 is a continuation-in-part of application No. PCT/SG2010/000378, filed on Oct. 4, 2010.
Application No. PCT/SG2010/000378 is a continuation-in-part of application No. PCT/SG2010/000341, filed on Sep. 16, 2010.

(30) Foreign Application Priority Data
Sep. 16, 2010 (SG) 201006753-6

(51) Int. Cl. H04N 13/02

(52) U.S. Cl. CPC H04N 13/0203
USPC 348/46

(57) ABSTRACT

An optical lens module assembly is disclosed which can perform “Auto Focus” and produce “3-Dimensional (3-D) images”, “2-Dimensional (2-D) video movies and still photographs” having all the objects in the area of it's view (field of view) to be fully focused. Due to the fact that all the objects in the field of view including the background is fully focused with high image quality, these video movies and still photographs can easily be converted to high quality 3-Dimensional (3-D) video movies and 3-D still photographs. The conversion may be done by using software or hardware or a combination of both software and hardware.

Further, due to artistic reasons, if it is required for the area towards the outer edges of the imaging area or photo or video to be made blur while the middle area is focused, then the outer areas can be made to be out of focus (blur image) while the middle part of the photo (image) or video can be made to be focused. Similarly, due to artistic reasons, if it is required for part towards the outer edges of the imaging area or photo or video to be made focused while the middle area is blur, then the outer areas can be made to be focused, while the middle part of the photo (image) or video can be made to be out of focused (blur image).

Further, these optical lens module assemblies can be also used in conventional 3D cameras, which use two separate camera modules. Also, these optical lens module assemblies can be used to replace the standard auto focus optical assemblies in all camera applications.

### BACKGROUND

Embodiments of the invention. relate to optical lens assemblies, camera systems and methods for recording 2-Dimension video and still images using a single image sensor and an optical lens module, but which can also produce high quality 3-D video movies and still photos.

1) Description of Related Art

The cameras having the standard auto focus is only capable of focusing only a given area which is within its field of view. The standard auto focus camera is not able to simultaneously focus all the objects Which are near (eg. 5 cm distance from camera lens or in contact with camera lens) and far (eg. up to infinity or a few tens of meters), onto the imaging plane of the image sensor or photographic film of the camera. This makes it impossible or very difficult for software and/or hardware to create a good quality 3-Dimensional video from a 2-D video, captured using a standard auto focus camera This is one reason for viewer to feel dizzy when watching 3D movies and photos. A common practice is to use two or more cameras to record video of a single scene and then later combine the two or more individual video recordings done by the two or more cameras, into one video in order to produce the 3 Dimensional video movies and still photographs.

Drawback of this method is the increase in the number of camera components required and there by the increase in the price of the video/still camera capable of capturing 3 Dimensional capable video and still images. In addition the requirement of post processing to create the 3D video from the individual video recordings makes it time consuming and requires additional equipment to create a 3d movie or video. The above requirements make it impossible for the fabrication of low cost 3D capable video or still cameras. With increasing demand for low cost 3-Dimension, miniaturized video and still capture capable cameras, a low cost camera system which is capable of capturing 3-Dimension video movies and still photos having an optical system incorporated to an imaging sensor is desired.

### SUMMARY OF EMBODIMENTS OF THE INVENTION

One embodiment of the invention relate to methods and systems of making an auto focus optical lens module assembly and a low cost video camera and imaging (still capture) camera which is capable of recording video and still images, which can be converted to high quality 3 Dimensional videos and 3-D still photos. Software and hardware can be used to create 3D video from 2D video. Also software and hardware combinations are available to create 3D video from 2D video. But there are no lenses or technology available at present, which can simultaneously focus all the objects which are near (example: 5 cm distance from camera lens or in contact with camera lens) and far (example: up to infinity or a few tens of meters or a few thousands of meters) onto the imaging plane of the image sensor or photographic film of the camera, except for the optical lens module assembly (lens module) disclosed in this patent application. Key to achieving good 3D photos or video, is to have an optical lens module assembly which can focus all objects in the area of view, focused on to the image sensor of the camera, to achieve a video or still image which is fully focused everywhere within the whole field of view. The above requirement cannot be fully met by using the optical lens modules and technologies available at present, except with the optical lens module assembly and the technology disclosed in this patent application.

Various arrangements may be envisaged to achieve focusing of the whole area, which is visible through the optical system of the camera, onto the image sensor or film, used to capture the video movie or still photograph.

Embodiments of the invention are particularly advantages when providing an optical imaging lens system which is capable of simultaneously focusing light rays originating from objects disposed at various distances on to a first focal plane which is maintained at a fixed distance from the lens assembly. Hence, embodiments of the invention enable imaging devices in small and compact form factor to produce quality 3-Dimension capable video and still images.

Here, what is meant (intended) by the term “3-Dimension capable” is to generate 3-Dimension video movie or 3-D still photographs using a combination of software and hardware, from the original 2-Dimension video movie or still photograph. The application areas are in the mobile communications such as mobile phones, laptops, smart phones, mobile multimedia devices, web cams, camcorders, cameras, digital cameras, photographic film camera, medical camera, television camera and compact camera modules, but not limited to the above applications.

The key to converting a 2-Dimension video or still image to a high quality 3-D video or still image is that the images of all the objects which are near and far in the field of view should be fully focused and should not have blur regions in the 2-D video or 2-D still photo. The optical lens module assembly and camera system disclosed herein provide 2-Dimension videos and still images which fulfills the requirement of having all the objects in the field of view to be fully focused and have no blur areas, in order to obtain high quality converted 3-Dimension video and still images.

In another embodiment, in order to view 3 dimension still photos and videos in a regular display (which is not 3-D display), the still photo or video may be colour coded and viewed through appropriate colour filters.

In another embodiment, in order to view 3 dimension still photos and videos in a regular display (which is not 3-D display) of a mobile phone or other mobile device or equipment, the still photo or video may be colour coded and viewed through appropriate colour filters.

In another embodiment, due to artistic reasons, if it is required for the area towards the outer edges of the imaging area or photo or video to be made blur while the middle area is focused, then the outer areas can be made to be out of focus (blur image) while the middle part of the photo (image) or video can be made to be focused. Similarly, due to artistic reasons, if it is required for part towards the outer edges of the imaging area or photo or video to be made focused while the middle area is blur, then the outer areas can be made to be focused while the middle part of the photo (image) or video can be made to be out of focused (blur image).

In another embodiment, an optical lens module assembly having plurality of through holes is disclosed. The hole dimensions can range from a few millimeters to a few nano meters.

In another embodiment, a method to secure the lens holder onto the printed circuit board of the camera module is disclosed. A lens holder comprises special alignment features (protrusions) for easy assembly of camera module. One or more protrusions traverse through the through holes located on the printed circuit board or the back cover of the camera module. These protrusions which have passed through to the other side of the through holes located in the printed circuit board are glued or made to become larger than the through hole so that it will not go back out through the through hole, thereby attaching (securing) the lens holder to the printed circuit board or the back cover of the camera module.

### BRIEF DESCRIPTION OF THE DRAWINGS

FIG. 1) illustrates an optical camera system assembly having a lens assembly with the capability of focusing both- far and near objects simultaneously and the image capture sensor placed at the focal plane. Here the optical lens system has multiple regions and/or components.

FIG. 2) illustrates an optical camera system assembly having a lens assembly with The capability of focusing both tin and near objects simultaneously and the image capture sensor placed at the focal plane. Here the optical lens system has multiple components.

FIG. 3) illustrates flow chart showing the process flow for viewing 2-D video movies and 2-D still photographs in 3-Dimensions, directly from mobile phone or any other camera or imaging device, after conversion to 3-Dimensions.

FIG. 4) illustrates one operation and/or operational modality of the optical lens module assembly.

FIG. 5) illustrates another operation and/or operational modality of the optical lens module assembly.

FIG. 6) shows an example operation flow (sequence) of the optical lens module assembly, but is not limited to this sequence,

FIG. 7) shows the optical module assembly having plurality of through holes.

FIG. 8) shows the schematic sequence of attaching the lens holder on to the printed circuit board or back board of the camera module.

### DETAILED DESCRIPTION OF ILLUSTRATIVE EMBODIMENTS

In the following description, numerous specific details are set forth in order to provide a thorough understanding of various illustrative embodiments of the invention. It will be understood, however, to one skilled in the art, that embodiments of the present invention may be practiced without some or all of these specific details. In other instances, well known process operations have not been described in detail in order not to unnecessarily obscure pertinent aspects of embodiments being described.

In one embodiment, a camera system having a special optical system and image sensor used for capturing video and still images which are fully focused is disclosed. The special optical system consists of an assembly which is operable to simultaneously focus light rays originating from various distances onto a first focal plane. More particularly, parallel, convergent or divergent light rays from objects at near distances (example: at least a few millimeters), parallel or convergent or divergent light rays from objects at near distances as near as in contact (example: zero millimeters), and parallel or near parallel light rays from far object or objects at near infinity distances or objects at infinity distances may be simultaneously focused onto a first focal plane while maintaining quality focus of a formed image within an acceptable tolerance limit

The imaging surface of the image sensor or photographic film is placed at the first focal plane. Image sensor may he a device which is used to capture the image formed on the image sensor by means of converting the image information to electrical information or electrical signals. In certain embodiments, a separation distance between a second focal plane where an image of a near object may be formed and a third focal plane Where an image of a far object may be formed should have an acceptable tolerance limit. The first focal plane may be suitably maintained at a fixed distance from the lens assembly when the optical system is focusing on objects at near distances, or objects at near infinity distances, or both. Thus, when focusing objects at various distances, the optical system does not require varying a relative distance between the lens assembly and a first focal plane or an image plane on which images of the objects are focused onto be captured by an image sensor or photographic film. In other words, the first focal plane, where images are formed for capturing of objects disposed at various distances, including near distances and near-infinity distance, is fixed relative to the lens assembly. Since a relative movement between lenses is not necessary when performing a focus function, the optical system would require less space and less power. The image plane may he provided as part of an image sensor, such as but not limited to, a charged couple device (CCD) sensor, a complementary metal oxide semiconductor (CMOS) sensor or a photographic film.

In one embodiment, the optical lens module assembly which can perform the above stated focusing function (focusing of near and far objects simultaneously) has a few aspects which are disclosed herein. The different regions of the optical lens module assembly respond to the light rays passing through the optical lens module assembly and makes all the light rays focus onto an imaging plane (within an acceptable tolerance in the focusing and/or spot size).

In another embodiment, the optical lens module assembly which can perform the above stated focusing function (focusing of near and far objects simultaneously).

The different regions of the optical lens module assembly respond to the light rays passing through the optical lens module assembly by changing the optical properties and/or physical properties and/or electro magnetic properties and/or physical properties and/or physical dimensions of the regions and makes all the light rays focus onto an imaging plane (within an acceptable tolerance in the focusing and/or spot size).

In another embodiment, the optical lens module assembly which can perform the above stated focusing function (focusing of near and far objects simultaneously). In another embodiment, The different regions of the optical lens module assembly respond to the light rays passing through the optical lens module assembly and the reflection of the light rays from the image sensor. The re-arrangement of optical and/or physical properties in different regions of the optical lens module assembly in response to the reflected light rays from the image sensor makes all the rays focus onto an imaging plane (within an acceptable tolerance in the focusing and/or spot size).

In another embodiment, the optical lens module assembly which can perform the above stated focusing function (focusing of near and far objects simultaneously) may have a few aspects which are disclosed herein. The different regions of the optical lens module assembly respond to the light rays passing through the optical lens module assembly and the reflection of the light rays from the image sensor. The re-arrangement of optical and/or physical properties in different regions of the optical lens module assembly in response to both the reflected light rays from the sensor and incident light on the optical lens module assembly makes all the rays focus onto an imaging plane (within an acceptable tolerance in the focusing and/or spot size).

In another embodiment, the focusing of the image onto the image sensor can he adjusted by varying the electrical input signals and electrical parameters of the image sensor.

In another embodiment, the focusing of the image onto the image. sensor can be adjusted by varying the functional parameters of the image sensor such as exposure, brightness, frame rate, but not limited to these parameters.

In another embodiment, due to artistic reasons, if it is required for the area towards the outer edges of the imaging area or photo or video to he made blur while the middle area is focused, then the outer areas can be made to be out of focus (blur image) while the Middle part of the photo (image) or video can be made to be focused. Similarly, due to artistic reasons, if it is required for part towards the outer edges of the imaging area or photo or video to be made focused while the middle area is blur, then the outer areas can be made to be focused while the middle part of the photo (image) or video can be made to be out of focused (blur image). The blurring may be done in many different methods. For example, blurring can be done by manipulating the pixels of the image sensor which is used to capture the image formed by the optical lens module assembly or by post processing of the captured photo or video.

The video and still image captured by the camera system disclosed herein will have all the objects in its field of view to be fully focused. The feature of this optical lens module assembly, being able to provide fully focused video and still images of all objects in its field of vine enables the creation of high quality 3-D videos and still images.

In another embodiment, the feature of this optical lens module assembly being able to provide fully focused video and still images of all objects in its field of view enables the creation of high quality 3-D videos and still images by conversion of the video and still images using software, hardware or a combination of both.

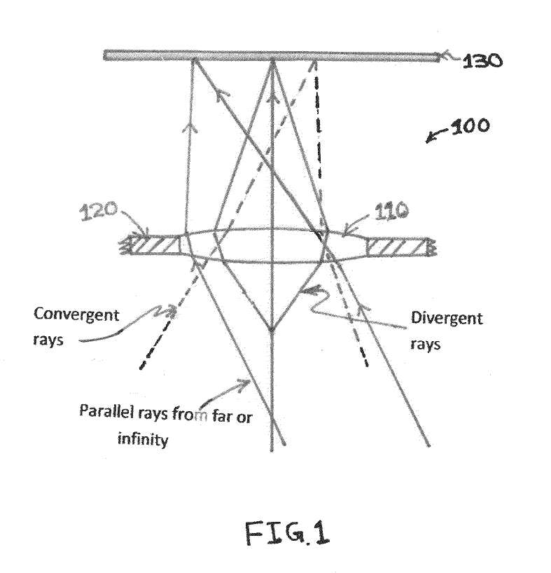

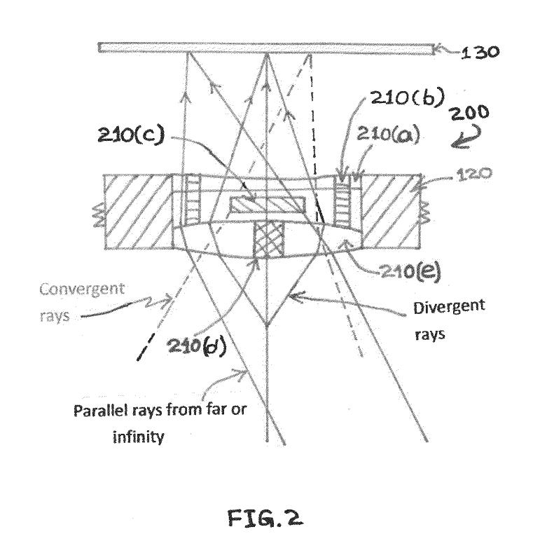

FIG. 1 and FIG. 2 show cross sectional views of the devices explained.

FIG. 1 illustrates an optical system according to one embodiment of the invention. The optical system 100 includes a lens 110. A retainer structure 120 as illustrated, but not limited as such, may he provided to support the lens 110. Threads may be provided on the retainer structure 120 to facilitate installation or mounting of the optical system 100 to an external body or device.

As illustrated, parallel, convergent or divergent light rays from near objects, and parallel or near parallel light rays from objects at near infinity distances may be simultaneously focused onto a first focal plane or image plane or image sensor 130 which may be maintained at a fixed distance from the lens assembly 110.

FIG. 2 illustrates the embodiment of FIG. 1 in cooperation with an array of optical elements within the lens assembly 200.

The lens assembly 200 includes an array of optical elements, 210(a), 210(b), 210(c), 210(d), 210(e), but not limited to the illustration.

The number of optical elements, dimensions and orientation of each element is not limited to illustration.

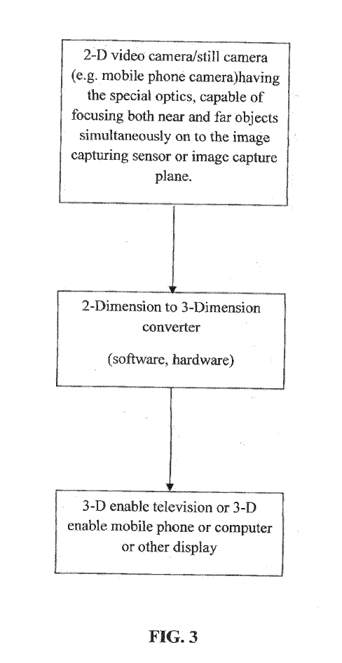

FIG. 3 illustrates an example flow chart for using the mobile phone to directly playback video movies and still images which can be viewed as 3-D video movies and 3-D still photos through a suitable display 330. The high quality 2-D video or 2-D still photo captured by the camera system disclosed herein is converted to 3-D video or 3-D still photo by the converter 320. The mobile phone 310 is equipped with a 2-D video and still camera with the optics capable of focusing near and far objects simultaneously onto the image capture sensor or image capture plane, illustrated in FIG. 1 and FIG. 2, but not limited to these illustrations.

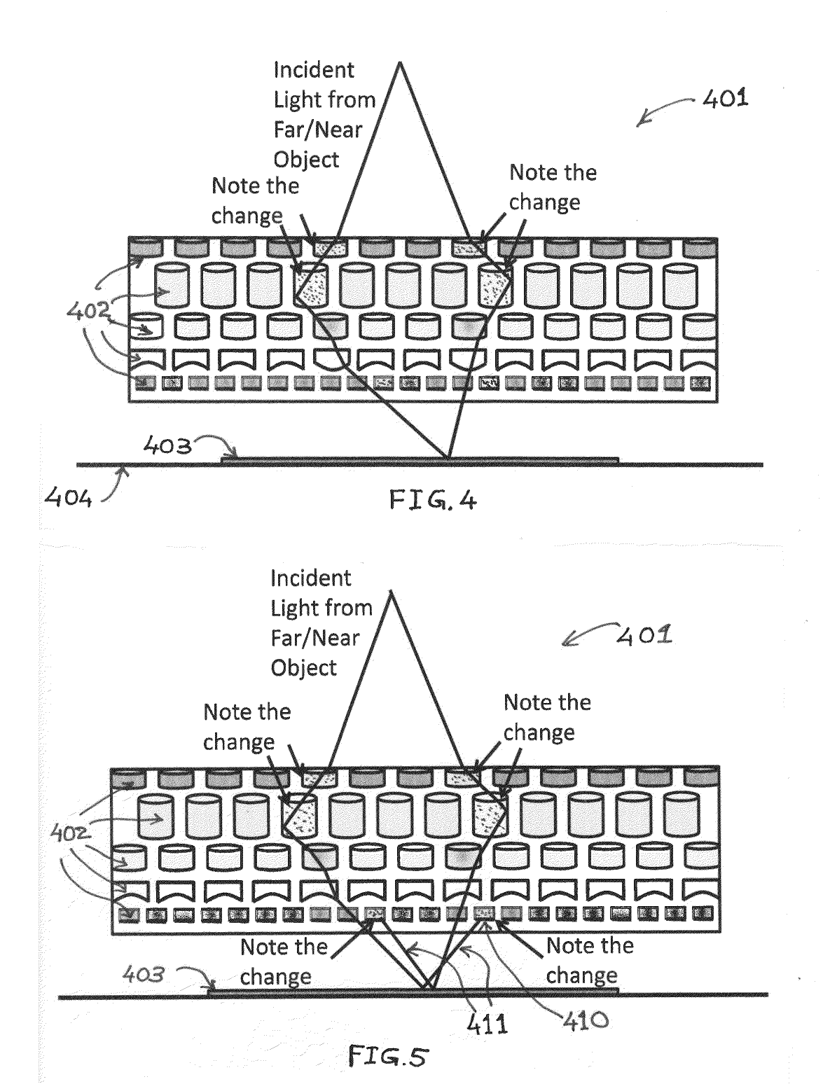

In another embodiment, FIG. 4 provide a brief illustration of one operating modality of the optical lens module assembly 401. The optical lens module assembly contains regions 402 which can interact with light, which is incident upon it and thereby focus the light onto the image sensor 403.

FIG. 5 provide a brief illustration of another operating modality of the optical lens module assembly 401. The optical lens module assembly contains regions 402 which can interact with incident light, and regions 410 which can interact with reflected light 411 from the image sensor 403. These interacting regions focus the light onto the image sensor 403.

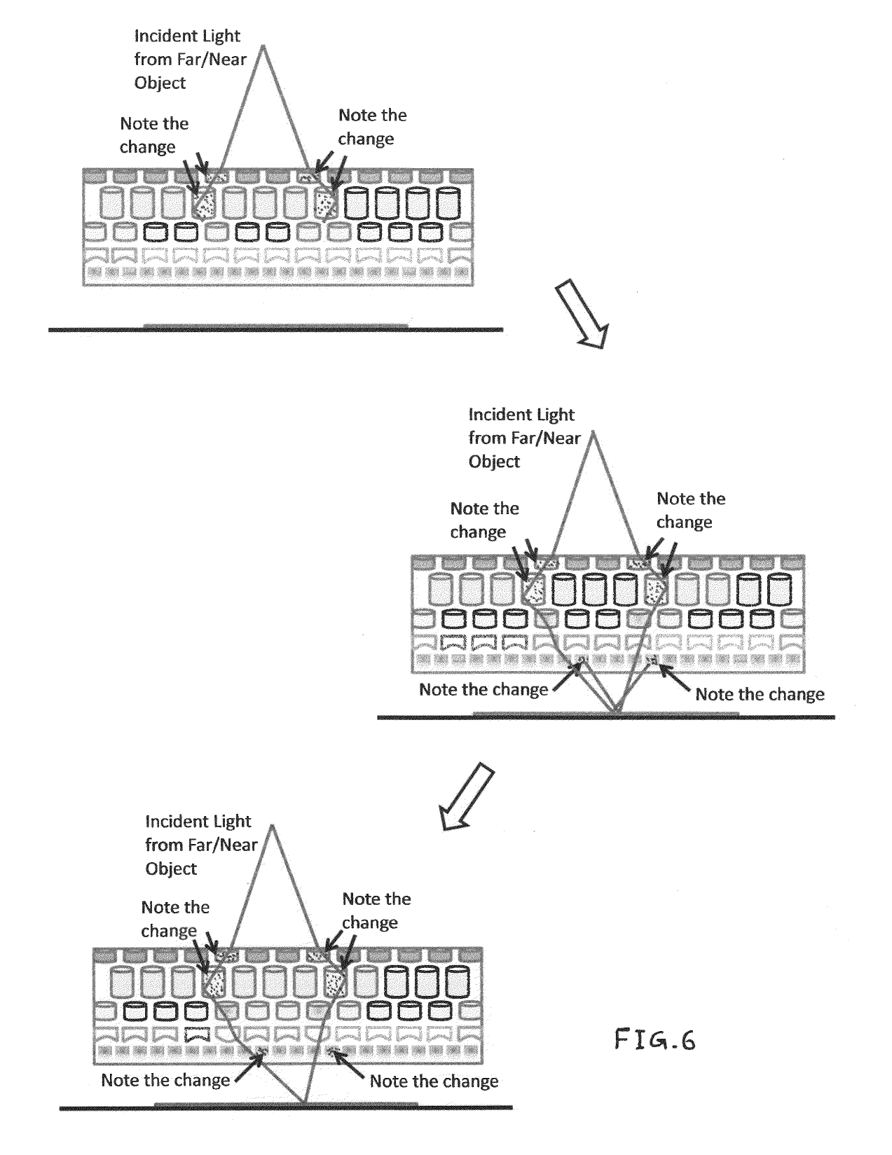

FIG. 6 provide a brief illustration of one operating modality sequence of the optical . lens module assembly disclosed herein, but it is not limited to this sequence.

The regions referred to in FIG. 4, FIG. 5 and FIG. 6 may or may not have dimensions in the range of a few nano meter.

In one embodiment, regions shown in FIGS. 4, 5, 6, may be in physical contact with each other.

In another embodiment, regions shown in FIGS. 4, 5, 6, may not be in physical contact with each other.

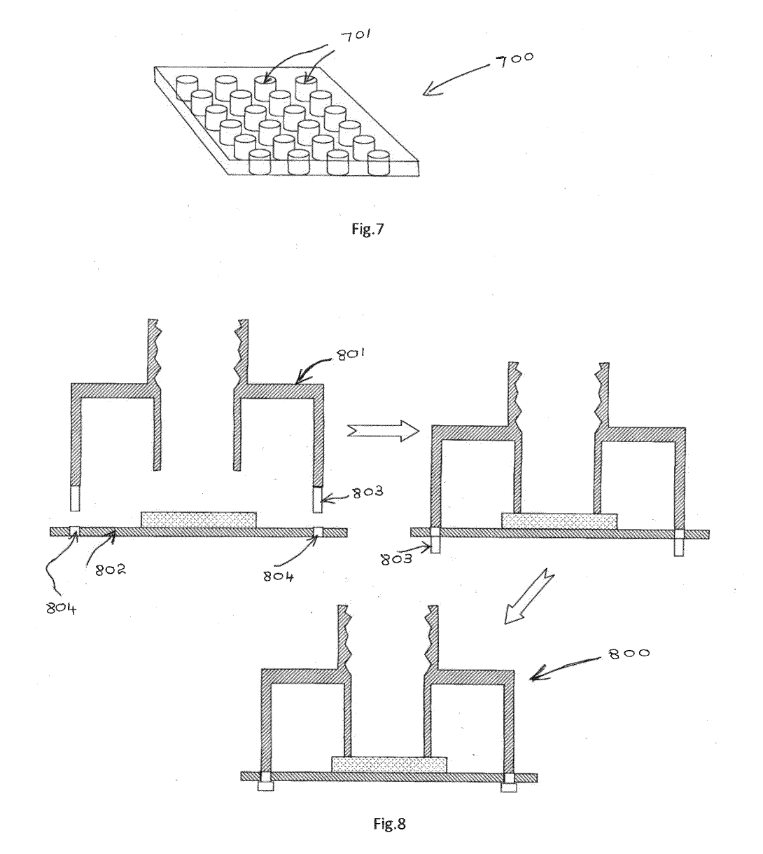

In another embodiment, an optical lens module assembly having plurality of through holes 700 is disclosed. FIG. 7) shows the optical module assembly having plurality of through holes 701. The hole dimensions can range from a few millimeters to a few nano meters.

FIG. 8) shows the schematic sequence of attaching the lens holder 801 on to the printed circuit board 802 or back board of the camera module 800. A method to secure the lens holder onto the printed circuit hoard of the camera module is disclosed. A lens holder comprises special alignment features 803 (protrusions) for easy assembly of camera module. One or more protrusions traverse through the through holes 804 located on the printed circuit board 802 or the back cover of the camera. module. These protrusions which have passed through to the other side of the through holes located in the printed circuit board are glued or made to become larger than the through hole so that it will not go back out through the through hole, thereby attaching (securing) the lens holder to the printed circuit board or the back cover of the camera module.

What is claimed is:

1. An optical camera system comprising:
an optical lens module assembly, wherein the lens assembly is operable to simultaneously focus a plurality of light rays originating from a plurality of distances, onto a first focal plane which is maintained at a fixed distance from the lens assembly.

2. The system of claim 1, where in a separation distance between a second focal plane where an image of a near object is formed and a third focal plane where an image of a far object is formed may have a tolerance of about +/−300 micrometers.

3. The system of claim I. where in the first focal plane is at a position in between the positions of second focal plane and the third focal plane.

4. The system of claim I, where in an image capturing sensor device or photographic film is placed at the first focal plane.

5. The camera system of claim 1, is capable of producing focused, very sharp and clear video movies and/or still photographs of objects which are at near and far distances to the camera.

6. The system of claim 1, where in the objects in the captured still photographs and video movies have very sharp edges, creating very sharp and high resolution photos and videos. Thereby enabling the video or still images obtained h the camera system to be easily converted to high quality 3-Dimensional video and still images using a combination of software and hardware.

7. The system of claim 1, wherein a ZOOM function is incorporated to the camera system.

8. The camera system and optical lens module assembly of claim 1, is used in applications which need the use of a camera. Some of the applications are in mobile phones, Television, web cam, laptop camera, surveillance and security camera, medical camera (eg. Endoscope), inspection camera, door bell camera, automotive camera, conventional 3D camera which use two camera modules side by side.

9. The optical lens module assembly of claim 1 consists of a plurality of regions and components.

10. The optical lens module assembly of claim 1 consists of a plurality of regions and components in the nano dimensions.

11. The optical lens module assembly of claim 1 consists of a plurality of regions and components which interact with light.

12. The optical lens module assembly of claim 1 consists of a plurality of regions and components which is sensitive to and interact with external energy, where the energy may be one or more of the following but not limited to light energy, thermal energy, electro mechanical energy, electro magnetic energy, chemical energy, electrical energy, or any other appropriate energy.

13. The optical lens module assembly of claim 1 consists of a plurality of regions and components which react to the incident light or some form of energy and thereby focus all the light rays traveling through the optical lens module assembly onto an optical plane having an acceptable spot size or tolerance in the out of focus component, during the process of attaining equilibrium within the optical assembly.

14. The optical lens module assembly of claim 1 may be operated in such a way that only the middle part of the image is focused/sharp, while the surrounding part is not focused/blur or only the middle part of image is not focused/blur, while the surrounding part is focused/sharp.

15. The optical lens module assembly of claim 1 may be operated in such a way that focusing of different regions can be controlled by adjusting the operating parameters of the image sensor which is used together with the optical lens module assembly in order to capture the image formed by the lens assembly.

16. The focusing operation in optical lens module assembly of claim 1 may be controlled by adjusting the electrical signals supplied or applied to the image sensor, which is used together with the optical lens module assembly in order to capture the image formed by the lens assembly.

17. The focusing operation in optical lens module assembly of claim 1 may be controlled by the reflecting light component, of the light incident on the image sensor. The reflected light may interact with the optical lens module to make the light passing through the optical lens module assembly to be focused on to the image sensor, which is used together with the optical lens module assembly in order to capture the image formed by the lens assembly.

18. The optical lens module assembly of claim 1, which may perform the focusing of near and far objects simultaneously comprises:
Plurality of regions.
The plurality of regions of the optical lens module assembly respond to the light rays passing through the optical lens module assembly by changing the optical properties and/or physical properties and/or electro magnetic properties and/or physical properties and/or physical dimensions of the regions and makes all the light rays focus onto an imaging plane (within an acceptable tolerance in the focusing and/or spot size).

19. An optical lens module assembly comprising:
plurality of through holes and/or plurality of optically transparent regions made on an opaque substrate, which may be fabricated directly on the surface or the protective cover of the image sensor or may be fabricated separately and later incorporated with the image sensor to form the camera module.
Is operable to simultaneously focus a plurality of light rays originating from a plurality of distances, onto a first focal plane which is maintained at a fixed distance from the optical lens module assembly.

20. A lens holder comprising special alignment features for easy assembly of camera system of claim 1 comprising:
one or more protrusions which traverse through, through holes located on the printed circuit board or the back cover of the camera module.
These protrusions which have passed through to the other side of the through holes located in the printed circuit board are glued or made to become larger than the through hole so that it will not go hack out through the through hole, thereby attaching the lens holder to the printed circuit board or the back cover of the camera module.

21. A method for blurring selected regions of a photograph or video movie captured in claim 6, comprises:
Manipulating the pixels of the image sensor used to capture the image or video. Post processing the captured photo or video.
